(19) United States
(12) Patent Application Publication
(10) Pub. No.: US 2022/0260378 A1
(43) Pub. Date: Aug. 18, 2022

(54) Methods and Apparatus for Electric Vehicle Route Planning

(71) Applicant: Atlis Motor Vehicles, Inc., Mesa, AZ (US)

(72) Inventor: Mark Hanchett, Mesa, AZ (US)

(73) Assignee: Atlis Motor Vehicles, Inc., Mesa, AZ (US)

(21) Appl. No.: 17/482,091

(22) Filed: Sep. 22, 2021

Related U.S. Application Data
(60) Provisional application No. 63/104,296, filed on Oct. 22, 2020.

(51) Int. Cl. G01C 21/34; G07C 5/08

(52) U.S. Cl. CPC G01C 21/3461; G07C 5/0808; G01C 21/3484

(57) ABSTRACT

A system may identify potential routes between a starting location and a destination for travel by an electric vehicle. The system may use data to assess the feasible and/or desirable of each route for the electric vehicle. Data for assessing a route may include the load weight and/or gross weight of the electric vehicle and/or a trailer pulled by the electric vehicle. The information used to assess a route may further include road gradient, altitude, battery range, data collected by the electric vehicle on a previous trip along the route, geographic, road condition and/or atmospheric condition information. A result of assessment may include the amount of energy used or the time spent to travel a route. The system may select the route for travel or provide potential routes with the results of assessment to a driver for selection.

### BACKGROUND

Embodiments of the present invention relate to electric vehicles and in particular to route planning for an electric vehicle.

Travel in an electric vehicle is constrained by the range of the battery, the proximity of recharging stations and the rate of consumption of energy from the battery. Users of electric vehicles would benefit from a system that plans a route that takes into consideration the weight of the electric vehicle, the weight of a trailer pulled by electric vehicle, if any, atmospheric conditions, the gradient (e.g., grade of road) of the potential routes and/or time to destination in addition to range, proximity of recharging stations and rate of consumption of energy from the battery.

### SUMMARY

Various embodiments of the present disclosure relate to systems for planning the route traveled by an electric vehicle. When selecting a route for travel, the system may consider such factors as the weight of the electric vehicle including its load; the weight of the trailer and its load, if being pulled by the electric vehicle; atmospheric conditions such as amount and type of precipitation, wind speed and direction, temperature, and road condition; and geographic data such as distance between starting location and destination, road grade along the route, charging station locations, elevation changes; range information, which includes the amount of energy stored by the battery, the rate of energy usage from the battery, and/or the distance to the next charging station.

The system may identify various routes and assess each route in accordance with the above information. Range information and energy usage may be based on energy required by the traction motors to traverse a route of a particular length and/or gradient. Estimates for evaluating and comparing various routes may further include energy usage by the electric vehicle in accordance with the weight of the vehicle and/or the weight of the vehicle and a trailer pulled by the vehicle. The system may evaluate identified routes in accordance with any of the above factors or combination thereof. After evaluation, the system may identify a preferred route for travel by the electric vehicle. Further the system may identify unacceptable routes that cannot be used due to factors such as excessive distance between charging stations. Criteria used by the system to select a route may include energy usage, such as total energy used, and the amount of time to travel from the starting location to the destination.

An electric vehicle may record data as it traverses a route. The data collected and recorded may include road gradient, road condition, atmospheric conditions, vehicle weight, trailer weight, rate of energy use, route traveled, and the location of charging stations. The electric vehicle may provide recorded data to a server for storage in a database. The data collected may be associated with the route for subsequent use in evaluating the same route for travel under different circumstances. Data from past trips may be compared to the factors affecting the present trip to increase the accuracy of evaluating any particular route for travel.

An electric vehicle may further use driver characteristics as a factor when evaluating a route. Driver characteristics include the driving characteristics of a particular driver. For example, rate of acceleration (e.g., slow, normal, high), braking (e.g., easy, normal, hard) and cornering (e.g., easy, normal, hard). Driver characteristics for the driver of the electric vehicle may be considered when evaluating routes because driving characteristics can affect the rate of consumption of energy from the battery thereby affecting the desirability and/or feasibility of a route.

### BRIEF DESCRIPTION OF THE DRAWING

Embodiments of the present invention will be described with reference to the drawing, wherein like designations denote like elements, and:

FIG. 1 is a diagram of an example embodiment of a system for evaluating a route of travel for an electric vehicle.

FIG. 2 is a diagram of an example embodiment of a vehicle computer and a trailer computer.

FIG. 3 is a diagram of an example embodiment of data for a database.

FIG. 4 is a diagram of an example of two potential routes.

FIG. 5 is a diagram of elevation between a starting location and a destination along the potential routes of FIG. 4.

FIG. 6 is a diagram of the grade (e.g., gradient) of the roads along the potential routes of FIG. 4.

FIG. 7 is a diagram of energy used by the electric vehicle versus weight along the potential routes of FIG. 4.

FIG. 8 is a diagram of time versus weight along the potential routes of FIG. 4.

FIG. 9 is a diagram of the range of an electric vehicle versus weight along the potential routes of FIG. 4 for different atmospheric temperatures.

FIG. 10 is a diagram of the time versus weight along the potential routes of FIG. 4 for different amounts of precipitation.

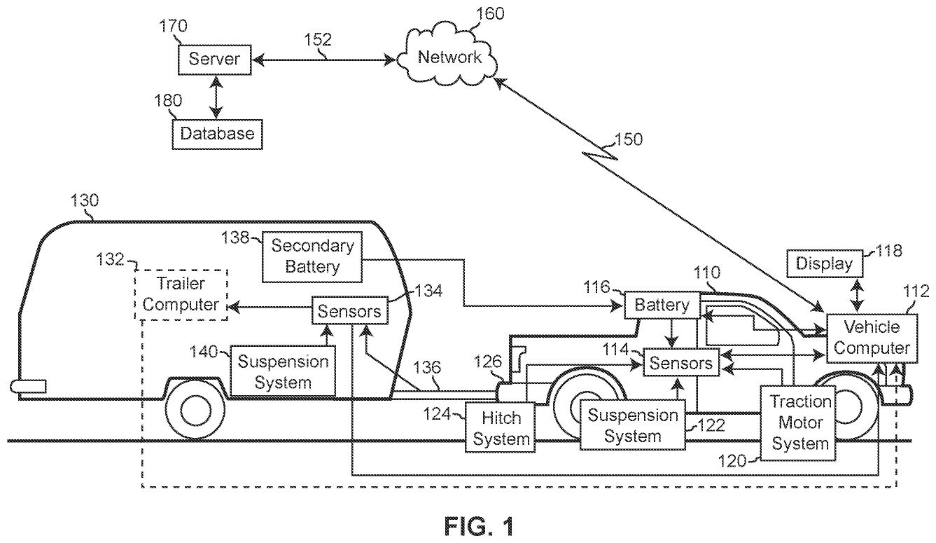

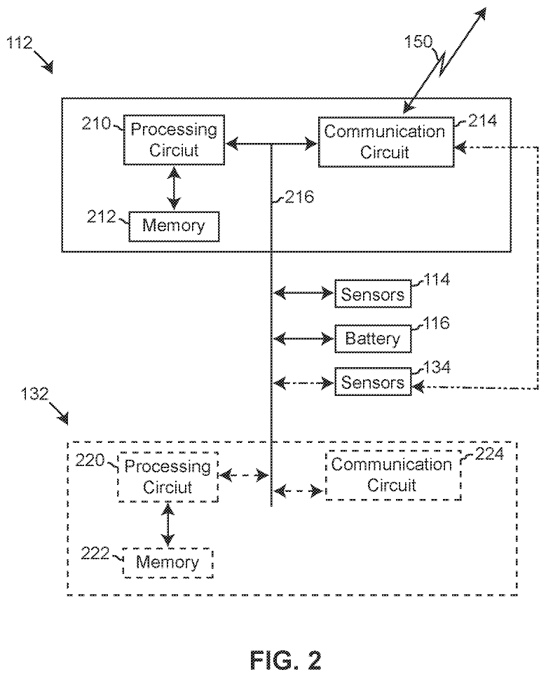

### DETAILED DESCRIPTION

### Overview

A system may plan a route of travel for an electric vehicle. The system may use map data to identify potential routes from a starting location to a destination. The map data may include information regarding roads, types of roads (e.g., dirt, paved, local, rural, interstate), the gradient (e.g., grade) of the roads, geographic features along a route (e.g., cities, towns, charging stations) and elevation data.

The system may analyze the potential routes to identify one or more desirable routes for travel. In evaluating the routes, the system may use factors such as the weight (e.g., load, curb, gross) of the electric vehicle; the weight of a trailer (e.g., load, curb, gross) pulled by the electric vehicle; atmospheric conditions; distance, grade, and elevation changes between starting location and destination; predicted rate of energy usage from the battery along a potential route, and the location of charging stations along the route. The system may further use data recorded from previous trips along a particular route to analyze the route under current conditions, which conditions may be different from the conditions from the data was recorded. The system may further use information regarding driver characteristics of the driver of the electric vehicle in assessing a particular route. Data recorded (e.g., captured, collected) during previous trips may be stored in a database 180 (e.g., 340). Information regarding driver characteristics may also be stored in the database 180 (e.g., 380).

Systems that identify and analyze routes include a server 170 and a vehicle computer 112. The server 170 or the vehicle computer 112 may identify and analyze routes by themselves or they may work together. If the server 170 identifies and analyzes the potential routes alone, the server 170 may need to receive data from the vehicle computer 112 such as, for example, date of the trip, starting location, destination, vehicle weight, trailer weight, traction motor size and power usage, battery type, battery capacity, current amount of energy stored in the battery, and the identity of the driver of an electric vehicle 110. If the vehicle computer 112 identifies and analyzes the potential routes alone, the vehicle computer 112 may need to receive data from the server 170 and/or the database 180. Data provided by the server 170 and/or the database 180 may include a map data 310, predicted environmental information 320 for the time of the trip, previous trips data 340, and driver characteristics 380.

After identifying and analyzing potential routes, an embodiment of the system may present on a display 118 the routes and a result of analysis to the driver, so the driver may select the route to be traveled. The display 118 may include an input device (e.g., keyboard) or be formed of a touchscreen for receiving data from the driver (e.g., user). The criteria for selection may include total energy use and amount of time needed to traverse the route. Other factors may include potential stress (e.g., wear-and-tear) on the systems of the electric vehicle, safety factors and/or even scenery along a route. In another embodiment, the system selects the route to be traveled. After analysis, the system (e.g., server 170, vehicle computer 112) may also rule out one or more potential routes as being impossible and/or impractical, for example if the charging stations are too far away from each other for the circumstances (e.g., weight, environmental factors, so forth).

As the electric vehicle 110 travels a route, the electric vehicle 110 may capture and record data for storage in the database 180. Capture data may include information such as starting location, start time, destination, end time, route, present time, date, temperature, present charge on battery, amount of energy expended, rate of energy usage along the route, road condition (e.g., traction), grade (e.g., gradient), environmental factors, vehicle weight, trailer weight, identity of the driver, and driving characteristics of the driver. The electric vehicle 110 may include sensors for detecting physical properties, capturing data regarding the physical properties and recording the data to provide a record of the trip.

The database 180 may further store information regarding the driving characteristics (e.g., 380) for particular drivers. The driving characteristics for particular driver may be used to assess the effects of a particular drivers habits on the performance of the electric vehicle 110 along a particular route.

### Example Embodiments of a System for Selecting and Analyzing Routes

An example embodiment of a system 100 for identifying and evaluating routes includes the electric vehicle 110, the trailer 130, the network 160, the server 170, and the database 180. The server 170 accesses and maintains the database 180. Server 170 may receive information for storage in the database 180. The server 170 may access the database 180 and provide data (e.g., information) from the database 180. The server 170 may communicate with other systems, such as the vehicle computer 112, via the network 160. Communication (e.g., transmit, receive) between the server 170 and the vehicle computer 112 may include communication via a wired communication link 152 and a wireless communication link 150.

In another example embodiment of the system 100 for identifying and evaluating routes, the electric vehicle 110 includes a vehicle computer 112, a first sensor 114 and the battery 116. The vehicle computer 112 includes a communication circuit 214. The first sensor 114 is coupled to the vehicle computer 112. The first sensor 114 is adapted to provide a first data regarding a physical characteristic of a system (e.g., 120, 122, 124) of the electric vehicle 110 to the vehicle computer 112. The battery 116 provides and energy to move the electric vehicle 110. In particular, the battery 116 provides energy to a traction motor system 120 to move the electric vehicle 110. The vehicle computer 112 determines a first gross weight of the electric vehicle 110 in accordance with the first data from the first sensor 114. The vehicle computer 112 identifies one or more routes between a starting location (e.g., city A) and a destination (e.g., city B) in accordance with a map data. The map data may be provided to the vehicle computer 112 from the database 180 via the server 170 and the network 160. The vehicle computer 112 determines at least one of an amount of energy and a duration of time to travel each of the one or more routes from the starting location to the destination in accordance with the first gross weight of the electric vehicle. The vehicle computer 112 selects a route from the one or more routes in accordance with at least one of minimizing the amount of energy and the duration of time.

In another example embodiment, the vehicle computer 112 determines at least one of an amount of energy and a duration of time to travel each of the one or more routes in accordance with the first gross weight of the electric vehicle 110 and a second gross weight of a trailer 130 pulled by the electric vehicle 110.

In an example embodiment, the vehicle computer 112 determines a first gross weight of the electric vehicle 110 by calculating a load weight on the electric vehicle 110 in accordance with the first data from the first sensor 114 and adding the load weight to a curb weight of the electric vehicle 110 to determine the first gross weight of the electric vehicle 110. In an example embodiment, the vehicle computer 112 includes a memory 212. The curb weight of the electric vehicle 110 is stored in the memory 212. In another example embodiment, the curb weight of the electric vehicle 110 is stored in the database 180. The vehicle computer 112 receives the curb weight of the electric vehicle 110 from the database 180 via the server 170 and the network 160.

In an example embodiment, the electric vehicle 110 includes at least one of a suspension system 122 and a traction motor system 120. The first data includes at least one of an amount of compression of the suspension system 122 and an amount of force provided by the traction motor system 120 to move the electric vehicle 110 from a stop.

In another example embodiment, the electric vehicle 110 further includes a trailer 130. The trailer 130 is adapted to couple to and be pulled by the electric vehicle 110. The trailer 130 includes a second sensor 134. The second sensor 134 is adapted to provide a second data to the vehicle computer 112. The vehicle computer 112 determines a second gross weight of the trailer 130 in accordance with the second data from the second sensor 134. The vehicle computer 112 further determines at least one of the amount of energy and the duration of time to travel each of the one or more routes from the starting location to the destination in accordance with the first gross weight of the electric vehicle 110 and the second gross weight of the trailer 130.

### Determining Weight

The weight of the electric vehicle 110 and/or the trailer 130 can have a direct and possibly significant impact on the amount of energy or time used to traverse a route. Accordingly, the electric vehicle 110 may determine the load weight (e.g., gross weight−curb weight) and/or gross weight (curb weight+load weight) of the electric vehicle 110, the trailer 130, and/or electric vehicle 110 and the trailer 130 combined.

The electric vehicle 110 may include a vehicle computer 112, sensors 114, a battery 116, a display 118, a traction motor system 120, a suspension system 122 and a hitch system 124.

The battery 116 provides energy to the traction motor system 120 to move the electric vehicle 110. The sensors 114 may capture data regarding physical characteristics such as the amount of energy stored in the battery 116, the rate of discharge of the battery 116, the rate of energy usage of the traction motor system 120, the traction provided by the traction motor system 120, the rate of energy usage per revolution of a wheel, atmospheric information, vehicle performance information of the electric vehicle 110, the state of the suspension system 122, the state of the hitch system 124, and any other physical data related to the electric vehicle 110. The sensors may provide capture data to the vehicle computer 112. The vehicle computer 112 may store capture data. The vehicle computer 112 may provide capture data to the server 170 to storage in the database 180.

The sensors 114 may be used to detect the load weight on the electric vehicle 110, the gross weight of the electric vehicle 110, and/or the gross weight of the electric vehicle 110 and trailer 130. For example, the sensors 114 may detect the state (e.g., status) of the suspension system 122 to determine the load on the electric vehicle 110. For example, the sensors 114 may detect the state of compression of the suspension system 122 and from the amount of compression the vehicle computer 112 may determine the weight of the load on the vehicle.

The sensors 114 may detect the amount of energy provided to the traction motor system 120 and the movement (e.g., speed, acceleration) of the electric vehicle 110 that results. The vehicle computer 112 may use the data regarding the amount of energy expended and the resulting movement to determine the gross weight of the electric vehicle 110 or the gross weight of the electric vehicle 110 and the trailer 130 combined.

The sensors 114 may detect the tongue weight of the trailer 130 on the hitch system 124. The vehicle computer 112 use the data regarding the tongue weight to determine the load or gross weight of the trailer 130. The trailer 130 may include sensors 134 that may aid in determining the load weight and/or the gross weight of the trailer 130. The sensors 134 may detect the state of the suspension system 140. The sensors 134 may report the amount of compression of the suspension system 140 to the trailer computer 132 and/or the vehicle computer 112. In an example embodiment, the trailer computer 132 uses the suspension compression data determine the load weight of the trailer 130 and reports the load weight data of the trailer 130 to the vehicle computer 112. In another example embodiment, the sensors 134 report the suspension compression data to the vehicle computer 112 and the vehicle computer 112 calculates the load weight of the trailer 130. The sensors 134 may detect the force between the hitch 126 and the tongue system 136 and the resulting movement of the trailer 130. The sensors 134 may report the force and the resulting movement to the trailer computer 132. In an example embodiment, the trailer computer 132 uses the force and movement data to compute the gross weight of the trailer 130. The trailer computer 132 reports of the gross weight of the trailer 130 to the vehicle computer 112. In another example embodiment, the sensors 134 report the force and movement data to the vehicle computer 112. The vehicle computer 112 uses the force and movement data to compute the gross weight of the trailer 130.

The sensors 114 may detect via a hitch system 124 whether the trailer 130 is connected to the hitch 126. The presence or absence of the trailer 130 may be reported to the vehicle computer 112.

The sensors 114 and/or sensors 134 may detect any physical characteristic of the electric vehicle 110 and/or the trailer 130 that may provide information for calculating the load on the electric vehicle 110 and/or the trailer 130 or the gross weight of the electric vehicle 110 and/or the trailer 130.

The sensors 114 may capture any data that is desirable to capture and store regarding the trip being made by the electric vehicle 110. For example, the sensors 114 may capture any or all of the data described in previous trip data 340, any map data 310 related to the trip, any environmental information 320, any vehicle information 350 and/or any driver characteristics 380.

The vehicle computer 112 may further store information related to the electric vehicle 110 such as the curb weight, which is the weight of the electric vehicle 110 without any load. The vehicle computer 112 may store any information needed to convert energy expenditure, movement, force, or any other physical characteristics of the electric vehicle 110 and/or the trailer 130 into a load weight or a gross weight of the electric vehicle 110 and/or the trailer 130.

### Example Embodiment of the Vehicle Computer and the Trailer Computer

In an example embodiment, the vehicle computer 112 includes the processing circuit 210, the memory 212, the communication circuit 214 and the bus 216. The processing circuit 210 may include any type of circuits for executing a stored program. The processing circuit 210 may include any microprocessor, microcontroller, signal processor and/or any type of circuit. The memory 212 may include any type of memory including a semiconductor memory. The processing circuit 210 may access the memory 212 to store and/or retrieve data. The memory 212 may store the stored program that is executed by the processing circuit 210. The communication circuit 214 may communicate with other systems via wireless communication link 150. The processing circuit 210 uses the bus 216 to communicate with communication circuit 214 and other systems, such as the sensors 114, the battery 116 and/or the sensors 134. In an example embodiment, the processing circuit 210 communicates with the sensors 134 via communication circuit 214.

The memory 212 may store any data needed for the calculations performed by the processing circuit 210. The processing circuit 210 has access to data via the memory 212, the server 170 and/or the database 180 via the network 160 to identify and/or assess one or more routes. Data from the sensors 114 and/or the sensors 134 may be stored in the memory 212. Data from the sensors 114 and the sensors 134 may be transmitted to the server 170 via the network 160 for storage in the database 180.

In an example embodiment, the vehicle computer 112 includes a processing circuit 210 and a communication circuit 214. The processing circuit 210 is adapted to couple to a first sensor 114. The first sensor 114 is adapted to provide a first data regarding a physical characteristic of a system (e.g., 120, 122, 124) of the electric vehicle 110 to the processing circuit 210. The communication circuit 214 is adapted receive a map data 310; The processing circuit 210 determines a first gross weight of the electric vehicle 110 in accordance with the first data from the first sensor 114. The processing circuit 210 identifies one or more routes between a starting location (e.g., city A) and a destination (e.g., city B) in accordance with the map data. The processing circuit 210 determines at least one of an amount of energy and a duration of time to travel each of the one or more routes from the starting location to the destination in accordance with the first gross weight of the electric vehicle 110. The processing circuit 210 selects a route from the one or more routes in accordance with at least one of minimizing the amount of energy and the duration of time.

In an example embodiment, the processing circuit 210 identifies a respective location of one or more charging stations (e.g., R420, R422, R424, R426, R428, R430, R460, R462) along the one or more routes. The processing circuit 210 determines a range of the electric vehicle 110 in accordance with the first gross weight of the electric vehicle 110 and the trailer 130. The processing circuit 210 selects a route in which a distance between the one or more charging stations along the route are within the range of the electric vehicle 110.

The trailer computer 132 may or may not be present in the trailer 130. In an example embodiment, the trailer 130 does not include the trailer computer 132. When the trailer 130 does not include the trailer computer 132, the processing circuit 210 of the vehicle computer 112 communicates directly with the sensors 134 via the bus 216 and/or the communication circuit 214. In another example embodiment, the trailer 130 includes the trailer computer 132. The trailer computer 132 includes processing circuit 220, memory 222 and communication circuit 224. The processing circuit 220 may have the same characteristics and perform the same or similar functions as the processing circuit 210. The memory 222 may have the same characteristics and perform the same or similar functions as the memory 212. The communication circuit 224 may have the same characteristics and perform the same or similar functions as the communication circuit 214. The processing circuit 220 and/or the communication circuit 224 may communicate with the processing circuit 210 via the bus 216.

The processing circuit 220 may perform calculations and provide a result of the calculations to the processing circuit 210. The processing circuit 220 may receive data from the sensors 134 to perform calculations and to determine a result. The processing circuit 220 may determine the load weight and/or the gross weight of the trailer 130 as discussed above.

### Server

The server 170 may include any type of computer (e.g., computing device, processing circuit). As discussed above the server 170 may identify and evaluate routes in accordance with the factors also described above. The server 170 may communicate with the vehicle computer 112 via the network 160 and wireless communication link 150. The electric vehicle 110 may include a display 118. The vehicle computer 112 may receive data from the server 170 and may present the data to a user (e.g., driver) on the display 118. The user may respond to data from the server 170 via the display 118. A user may provide data to the server 170 and/or the vehicle computer 112 via the display 118.

In an example embodiment, the server 170 manages the database 180. The server 170 stores data in the database 180, retrieves data from the database 180 and/or arranges data (e.g., sort, put in order) in the database 180.

The server 170 may communicate with other systems, such as the vehicle computer 112 via the network 160. The network 160 may include any type of network and may communicate data using any communication protocol. The network 160 may communicate with systems and/or other electronic devices via wired or wired communication links, such as the wireless communication link 150 and the wired communication link 152.

### Database

The database 180 stores data for identifying and selecting a route for travel by the electric vehicle 110. As discussed above the server 170 may receive data and store the data in the database 180. For example, the server 170 may receive map data for identifying potential routes between the starting location and the destination. The server 170 may store all or part of the map data in the map data 310. The server 170 may receive weather forecasts for the date of travel. The server 170 may store all or part of the environmental information from the forecasts in the environmental information 320. The server 170 may receive data captured by the electric vehicle 110, or any other electric vehicle, during a trip. The server 170 may store data captured by the electric vehicle 110 during the previous trip in previous trip data 340. The server 170 may receive information (e.g., specifications, ratings) regarding the vehicle making the trip. The server 170 may store all or part of the vehicle data in vehicle information 350. The server 170 may receive data regarding driver characteristics. The server 170 may store information regarding characteristics of specific drivers in driver characteristics 380.

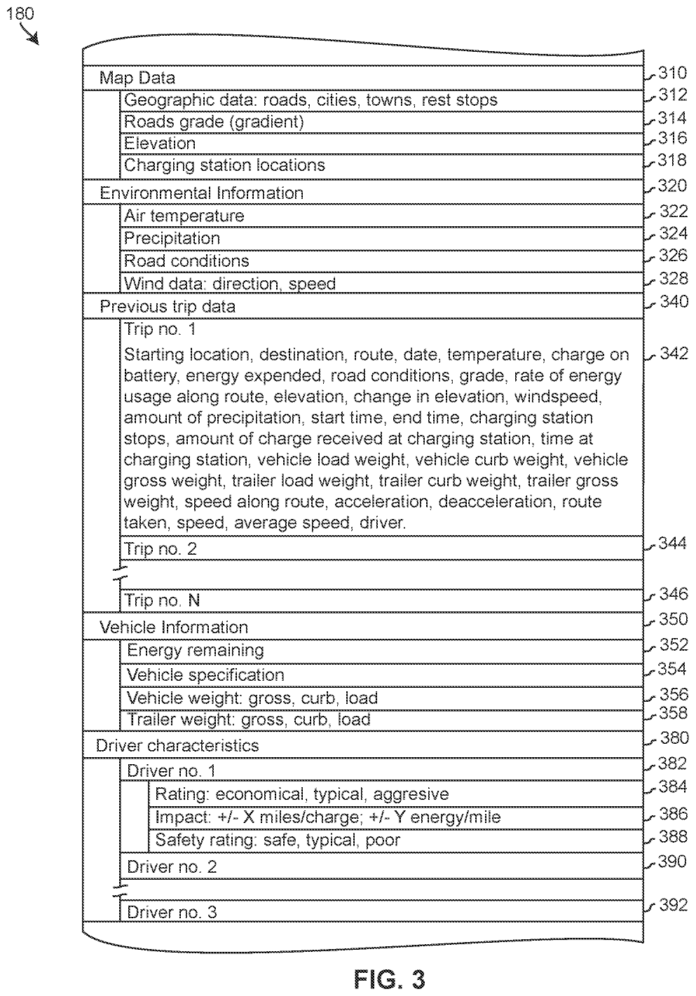

The server 170 may provide any information from the database 180 to the vehicle computer 112 via the network 160. The server 170 may further receive and store information regarding the trailer 130. Although trailer data is not specifically identified in the database 180, as shown in FIG. 3, the database 180 may store trailer related data. An embodiment of the database 180 shown in FIG. 3. The database 180 is not limited to storing information identified in FIG. 3. In the example embodiment, the database 180 stores the map data 310, the environmental information 320, the previous trip data 340, the vehicle information 350, and the driver characteristics 380. In another example embodiment, the database 180 further stores information regarding the plurality (e.g., fleet) of trailers.

In an example embodiment, the map data 310 stores the geographic data 312. The geographic data 312 may include data regarding the roads, cities, towns, rest stops, and so forth. The geographic data 312 may identify the type of road, the speed limit along a road, and other information used by a driver to navigate a road. The geographic data 312 may include information that is commonly used by a GPS receiver to identify routes between a start location and the destination. The map data 310 further includes a road grade 314. The road grade 314 includes the gradient (e.g., inclination, rate of ascent, rate of descent, slope) of the road at any location along the route of the road. The map data 310 includes elevation data 316 of any point along a road. Elevation data 360 may be used to calculate a change in elevation. The map data 310 further includes the charging station locations 318. The charging station locations 318 includes information regarding the geographic location of charging stations where the electric vehicle 110 may charge the battery 116. The charging station locations 318 identifies the roads that may access the various charging stations. The charging station locations 318 may further identify the type and capacity of the charging equipment located at a charging station thereby providing information as to how long it may take to recharge the battery 116. The charging station locations 318 may further include information regarding the throughput (e.g., vehicles charged per hour) of a charging station thereby providing further information as to how long it may take recharge the battery 116 at that particular location. The charging station locations 319 may further include data as to the cost of recharging at each charging station.

The environmental information 320 may include the air temperature 322, the precipitation 324, the road conditions 326 and the wind data 328. The environmental information 320 is information related to a forecast of the environmental conditions for the time of the trip. As with all forecasts, the forecast may not match reality when the day of the trip arrives. However, the data may be used to evaluate travel along the identified routes. The air temperature 322 may include information regarding the amount of sunlight (e.g., sunny, partially overcast, overcast) and the amount of humidity. The precipitation 324 may include information as to the type of precipitation (e.g., snow, rain, hail), the amount of precipitation, the starting time of the precipitation, the ending time of the precipitation, and the amount of precipitation. The road conditions 326 may include information regarding accumulation of precipitation (e.g., snow, ice, flooding). The road conditions 326 may include information related to potential loss of traction by the electric vehicle 110.

Previous trip data 340 includes data measured and recorded by sensors on the electric vehicle 110, or other electric vehicle, during a previous trip. Previous trip data 340 may be used to predict performance of the electric vehicle 110 along the same route under the same or conditions. The system for evaluating a route may assess the environmental and road conditions for travel along the same route under different environmental conditions and different road conditions. Previous trip data 342, 344 and 346 store data measured during trip nos. 1, 2 and N respectively. In an example embodiment, previous trip data 340 is stored in a separate database and is arranged by route.

Vehicle information 350 includes an energy remaining 352, a vehicle specifications 354, a vehicle weight 356, and a trailer weight 358. The vehicle information 350 is used to identify and assess potential routes between a starting location and a destination, so the energy remaining 352 is the amount of energy stored in the battery 116 at the beginning of the trip. The vehicle specifications 354 includes any specification information about the electric vehicle 110 that may be needed to assess travel along a particular route. The vehicle specification 354 may include the curb weight of the vehicle, the energy consumption specifications of the traction motor system 120, the compression specifications of the suspension system 122, the specifications of the hitch system 124, and the performance of the systems of the electric vehicle 110 at various temperatures and/or different loads. The vehicle weight 356 is the weight (e.g., curb, load, gross) of the electric vehicle 110 at the time of the trip. As discussed above, the sensors 114, the suspension system 122, the traction motor system 120, the hitch system 124 and the vehicle computer 112 may cooperate with each other to determine the vehicle weight 356. The trailer weight 358 is the weight (e.g., curb, load, gross) of the trailer 130 at the time of the trip. As discussed above the sensors 134 may cooperate with the suspension system 140, the tongue system 136, and the trailer computer 132 or the vehicle computer 112 to determine the trailer weight 358.

The driver characteristics 380 store data regarding how a particular driver operates a vehicle. In the example embodiment of FIG. 3, the driver characteristics 380 includes data regarding the driver no. 1 (e.g., 382), the driver no. 2 (e.g., 390) and the driver no. N (392). Data regarding a driver may include, for example, rating 384, impact 386 and safety rating 388. The rating 384 rates the driver as driving in an economical manner, a typical matter or an aggressive manner. The rating 384 may represent speed of operation as compared to the speed limit, the rate of acceleration and/or deceleration, and/or the centripetal forces that operate on the vehicle while turning. The rating 384 represents a measure of how hard a driver pushes the operation of a vehicle. The impact 386 represents the effect of the driver's driving characteristics on the performance of the electric vehicle 110. For example, how the driver's driving characteristics affect the number of miles traveled per charge and/or the amount of energy required to travel a mile. The safety rating 388 describes a measure of whether the driver safely operates a vehicle. The safety rating 388 may include information regarding past accidents, past collisions, and/or past citations. The safety rating 388 may include a safety level such as a safe, typical, poor.

The data of the database 180 may be used in any manner to evaluate travel along a particular route. Additional data may be received by the server 170 and/or the vehicle computer 112 for assessing a potential route. The data of the database 180 may be assigned any weight (e.g., importance) for assessment or data it may be ignored completely.

### Examples of Selecting a Route

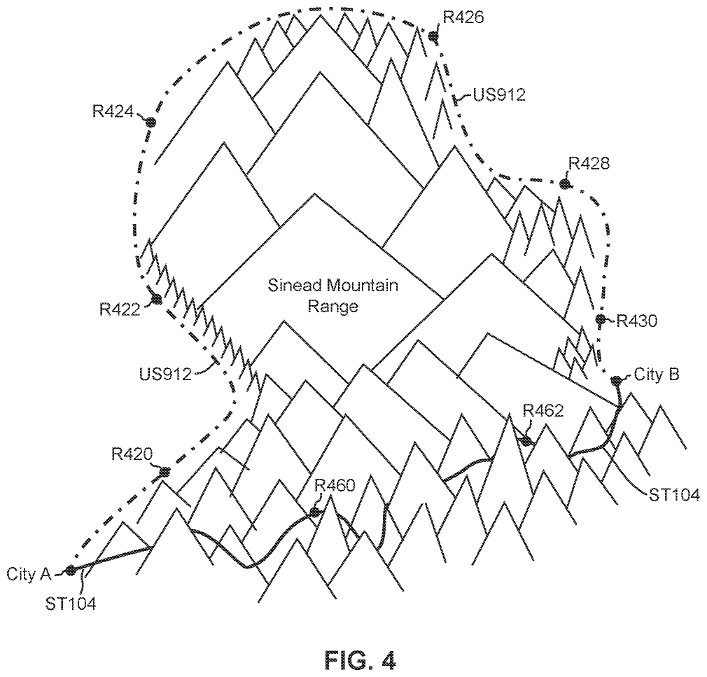

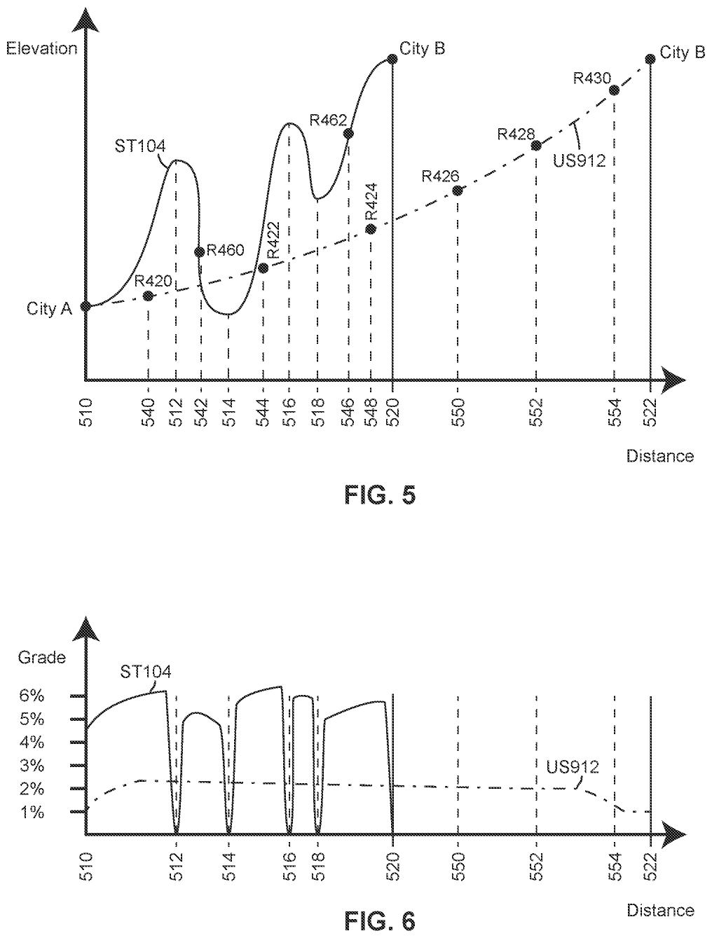

The example routes, US highway 912 (“US912”) and state highway 104 (“ST104”), as best seen in FIG. 4, may be used to illustrate how routes are identified and assessed. In this example, the driver of the electric vehicle 110 wants to travel from starting location city A to destination city B. ST104 on paper, as best shown in FIG. 4, appears to be the most direct and shortest route between city A and city B. However, the elevation changes and grade of the roads between city A and city B along ST104 and US912, as shown in FIGS. 5 and 6, are very different. The variations in elevation between city A and city B along ST104 are significant, whereas the variations in elevation along US912 from city A to city B less significant but consistent. Further, to accommodate the elevation changes, the grade of ST104 is steep, nearly an average approaching 6% grade both uphill and downhill. Whereas, the grade of US912, which varies between 1% and 3% averages about 2%, which is significantly less than the grade of ST104; however, US912 is significantly longer to avoid the mountains that ST104 traverses. Further, there are only two charging stations along ST104, whereas there are six charging stations along US912.

### First Example: Light Load

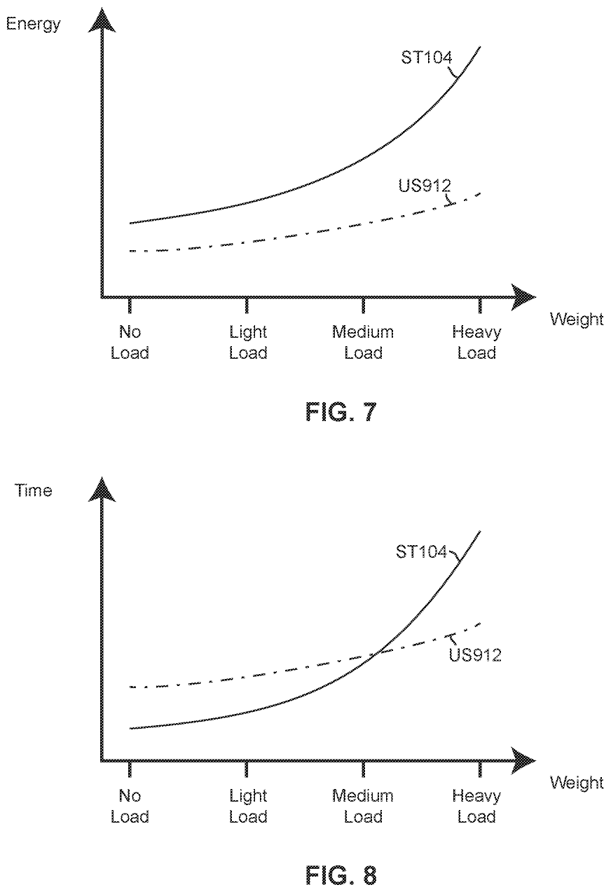

In one example, the electric vehicle 110 is not pulling the trailer 130, has a light load, and is fully charged at the beginning of the trip. The system (e.g., vehicle computer 112, server 170) for evaluating the routes ST104 and US912 may use data from the previous trip data 340, the vehicle specifications 354, or any other data available from the electric vehicle 110 and/or the database 180 to assess the performance of the electric vehicle 110 along the potential routes while lightly loaded. The data may be analyzed to produce the graphs shown in FIGS. 7 and 8. The graph of FIG. 7 shows the energy expended by the electric vehicle 110 to travel route ST104 or US912 in accordance with the weight of the electric vehicle 110. The weight identified in FIG. 7 may include the electric vehicle 110 alone (e.g., no load) or with trailer 130. The data of FIG. 7 shows that the energy expended by traveling along ST104 with no-load or a light load is only slightly more than the energy expended traveling along US912. However, as the load increases (e.g., medium load, heavy load), the energy used by the electric vehicle 110 to travel ST104 between the city A and the city B increases significantly.

The various loads, identified in FIGS. 7-10 as no load, light load, medium load and heavy load represent the gross weight of the vehicle and the trailer. The situation of no load occurs when the electric vehicle 110 is not pulling a trailer and has no load other than the driver. The other loading levels (e.g., light, medium, heavy) may represent any combination of loading on the electric vehicle 110 alone or the electric vehicle 110 in combination with the load of the trailer 130. For example, the electric vehicle 110 may be lightly loaded when it pulls no trailer, but is loaded close to its maximum capacity. The electric vehicle 110 may have a medium load when the combination of the load on the electric vehicle 110 and the trailer 130 is in the midrange capacity of the electric vehicle 110 and the trailer 130. The electric vehicle 110 may have a heavy load when both the electric vehicle 110 and the trailer 130 are loaded to their near maximum or maximum capacities. A heavy load does not occur unless the electric vehicle 110 is pulling the trailer 130 and both have some amount of load, if not the maximum rated loads.

The data may also be used to estimate the time required for the electric vehicle 110 to travel from city A to city B in accordance with the load on the electric vehicle 110 and the route taken. As shown in FIG. 8, the time for the electric vehicle 110 to travel ST104 is less than the time required for US912 for no-load and a light load. Apparently, when the load is light enough and the electric vehicle 110 can easily maintain the speed limit along ST104, the electric vehicle 110 may travel between city A and city B much faster along ST104 because the distance is significantly shorter than the distance along US912. As the load increases, dealing with the higher road grade along ST104 makes traveling along ST104 slower than US912 in spite of its shorter distance.

In this example of a light load, the system that assesses the routes may present the results of assessment to the driver on the display 118. The result shows a faster time along ST104 for the slight increase in energy usage or a longer time along US912 with a lesser amount of energy used. The user, according to the user's preference, may use the data to select which route will be travel.

In this example, neither route is ruled out. The system informs the driver via the display 118 that the battery 116 should be fully charged prior to leaving city A and that the driver will need to stop at recharging station R462 to charge the battery to at least 40% to successfully arrive at city B. Since the charging stations along either ST104 and US912 are close enough to each other to allow the electric vehicle 110 to stop in charge, neither route need be precluded.

The assessment may be performed using the weight of the electric vehicle 110 and of the trailer 130 as determined by the sensors 114, the sensors 134 and the vehicle computer 112, the server 170 and/or the trailer computer 132.

### Second Example: Medium Load

In another example, the electric vehicle 110 is not pulling a trailer, is fully charged prior to leaving for the trip, but is also carrying its maximum load. Using the stored data and the information calculated for FIGS. 7 and 8, the system determines that the electric vehicle 110 must start the trip with the battery 116 fully charged, must stop at both charging stations R460 and R462, and at each charging station should charge to at least 80% of the charge capacity of the battery 116. If the driver does not comply with the identified charging requirements, the electric vehicle 110 will not be able to traverse the route because the battery 116 will be fully depleted before reaching a charging station or the destination city B.

The graphs of FIGS. 7 and 8 provide the information that at a medium load, the trip from city A to city B along will take slightly less time than US912, but use more energy. The trade-off in time between ST104 and US912 is close, but the energy usage is not. The system may present the information, the results of analysis and the charging instructions to the driver for selecting the route.

Again, in this example, neither route was ruled out, but instructions were issued that need to be complied with if traveling ST104. The times shown in FIG. 8 include the time required to charge at charging stations along the way. The driver will need to charge the battery 116 at two, possibly three charging stations along US912, but since they are much closer together than on ST104, the driver will be able to choose which charging stations to stop at merely by watching the gauge showing remaining charge on the battery and range.

In another example, the electric vehicle 110 is not carrying a load, but is pulling trailer 130 with a load that results in an assessment of a medium load for the electric vehicle 110 and the trailer 130 combined. Since the combined load is a medium load, the assessment of travel along ST104 and US912 is the same as above.

### Third Example: Heavy Load

In another example, the electric vehicle 110 carries a full load and pulls a fully loaded trailer, which is characterized as a heavy load. The system using the available data assesses traveling from city A to city B along ST104 and US912. The graph in FIG. 7 shows that the energy consumption for a heavy load along ST104 is significantly greater than the energy consumption along US912. The graph in FIG. 8 also shows that the time to traverse ST104 with a heavy load is significantly greater than the time to traverse US912.

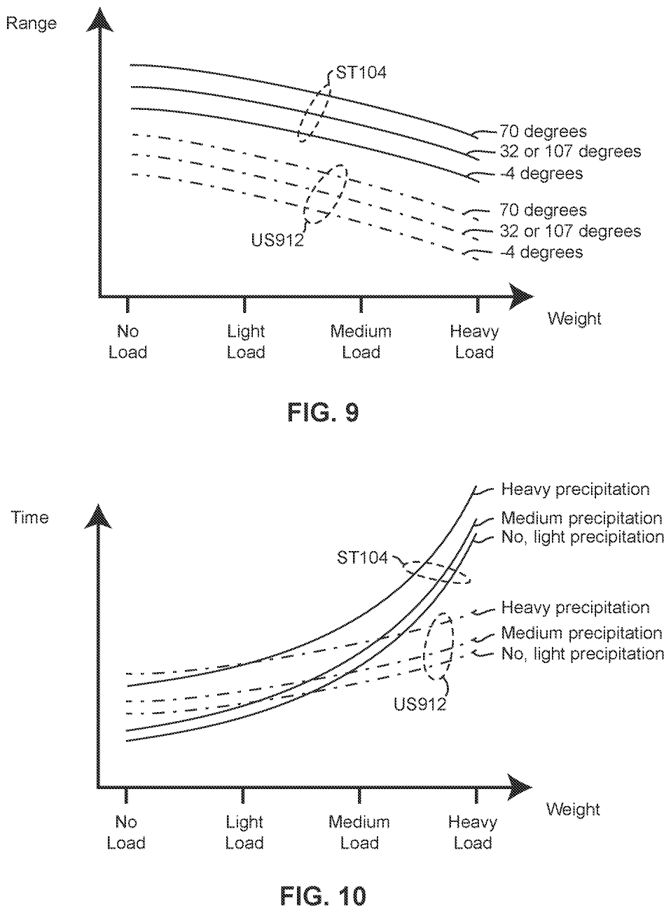

The graph of FIG. 9 also shows the range of the electric vehicle 110 along the routes ST104 and US912 in accordance with the atmospheric temperature and weight. As the weight of the electric vehicle 110 and the trailer 130 increases, the range for the fully charged the battery 116 decreases. The range along ST104 is always less than the range along US912 because of the steeper gradient of the road along ST104. The other factor shown in FIG. 9 is the effect of temperature on the range of the electric vehicle 110. The electric vehicle 110 has the greatest range and operates most efficiently at around 70° F. As atmospheric temperature either increases or decreases from 70° F., the efficiency and range of electric vehicle 110 decreases. In an example embodiment, the electric vehicle 110 cools or heats the battery 116 to compensate for either excessively cold or hot atmospheric temperature; however, the energy used to heat or cool the battery 116 decreases the range of electric vehicle 110.

The system uses the data from the database 180 and the electric vehicle 110 to determine that the electric vehicle 110 would fall short of charging station R462 even if the battery 116 is fully charged at the beginning of the trip stops and is fully recharged at charging station R460. As a result, the system precludes travel along ST104 due to the effects of the heavy load and the steep roads along ST104. The system even considers the amount of energy generated due to regenerative braking on the downhill slopes along ST104 in determining that the electric vehicle 110, due to its heavy load, cannot travel ST104.

In an example embodiment the trailer 130 includes a secondary battery 138 that provides power to the battery 116. The secondary battery 138 may increase the range of the electric vehicle 110 while heavily loaded to make transit along ST104 feasible with respect to having sufficient range to reach charging station R462; however, with a heavy load, as shown in FIG. 8, the time of transit of ST104 is significantly greater than the time of transit of US912. So, even if travel between city A and city B is possible with the secondary battery 138, it may not be desirable due to the increased amount of time.

After the system has assessed travel along both ST104 and US912, the system instructs the driver, via the display 118, to not take ST104 and to stop for full charging at charging stations R422 and R426 in addition to charging to at least 50% at charging station R428 or at least 35% at charging station R430. The system further informs the driver that it is best to not start the trip with less than 80% charge on the battery 116.

### Effects of Weather

Because poor weather may affect the speed a vehicle may travel, the system may receive forecasts of weather along the routes and use that information as a factor in determining the energy and/or time that will be expended, the best route to traverse, and where to recharge. Weather information may include the speed of any winds along the route and the angle (e.g., direction) of the winds with respect to the highway (e.g., tail wind, head wind, wind shear). Weather information may further include whether precipitation (e.g., water, rain, snow) on the highway may be frozen along the route. Weather information may include locations along a route that are historically icy at particular temperatures and/or times of the year. Such information may be used as a factor in determining a route.

The graph of FIG. 10 shows the amount of time for transit of ST104 and US912 with different loads and different amount of precipitation. For a particular load, the time of transit of US912 changes little when the precipitation is less than a medium amount. The time of transit of US912 increases when there is heavy precipitation, but the time difference along US912 for the conditions of no precipitation and heavy precipitation is less significant than along ST104 because US912 is a modern interstate designed to handle precipitation. As the graph in FIG. 10 shows, the time of transit of ST104 increases significantly with increasing amounts of precipitation. Even light precipitation can make the transit time along ST104 significant longer than along US912 depending on the load. Further, due to the mountainous terrain along ST104, it is possible to get heavy precipitation along ST104 while US912 experiences only light or possibly no precipitation.

### Effects of Driver Characteristics

The driving characteristics of an individual driver may also be a factor in assessing a potential route. Driving characteristics will have the greatest impact on energy economy (e.g., range per full charge, energy per mile).

### Methods for Selecting a Route

In a first example method, a computer performs the method to select a route for travel by the electric vehicle 110. The method includes identifying one or more routes, receiving a first gross weight, receiving a second gross weight, determining the amount of energy and/or the duration of time to travel each of the one or more routes, and selecting the route. Identifying one or more routes includes identifying one or more routes between a starting location (e.g., city A) and a destination (e.g., city B) in accordance with a map data 310. Receiving the first gross weight includes receiving the first gross weight of the electric vehicle 110. The first gross weight may be determined by the server 170 and/or the vehicle computer 112 in cooperation with sensors 114 and/or 134 as discussed above. The traction motor system 120 and/or the suspension system 122 may provide data for determining the load weight of the electric vehicle 110 and/or the first gross weight.

Receiving the second gross weight includes receiving the second gross weight of the trailer 130, if the trailer 130 is attached to the electric vehicle 110. The second gross weight may be determined by the server 170, the vehicle computer 112 and/or the trailer computer 132 in cooperation with sensors 114 and/or 134 as discussed above. The traction motor system 120, the suspension system 140 and/or the hitch system 124 may provide data for determining the load weight of the trailer 130 and/or the second gross weight.

Determining the amount of energy and/or the duration of time to travel each of the one or more routes includes determining in accordance with the first gross weight of the electric vehicle and/or the second gross weight of the trailer from the starting location to the destination. Determining may include developing estimates for energy usage and/or time in route for various weights, temperature and precipitation as shown in FIGS. 7-10 for each route. Calculating the information shown in the graphs of FIGS. 7-10 may use data based on the specifications of the systems of the electric vehicle 110 and the trailer 130 and/or data captured and recorded during previous trips.

Selecting the route includes selecting in accordance with a result of determining the amount of energy and/or the duration of time to travel each of the one or more routes. Selection may be made in further accordance with minimizing the amount of energy used by the electric vehicle 110 or the duration of time spent in transit. In an example embodiment, the system (e.g., vehicle computer 112, server 170) may select the route from the one or more possible routes and instruct the driver to take the selected route. In another example embodiment, the system presents the possible routes to the driver on the display 118 along with the results of assessing each possible route. The results may include the amount of energy used and/or the amount of time required to traverse the route. The driver is left to select the route.

In the first example method, determining the amount of energy and/or the duration of time to travel each of the one or more routes further includes determining in further accordance with at least one of a grade of a road along the one or more routes and a length of the one or more routes from the starting location to the destination. Determining the amount of energy and/or a duration of time to travel each of the one or more routes may further include determining in further accordance with a change in elevation along each of the one or more routes. Determining the amount of energy and/or the duration of time to travel each of the one or more routes may further include determining in further accordance with a range of electric vehicle for a remaining charge on the battery 116 of the electric vehicle 110 and a distance to a charging station (e.g., R420, R422, R424, R426, R428, R430, R460, R462).

In the first example method, receiving the first gross weight of electric vehicle 110 includes receiving a data from one or more sensors 114 related to a system (e.g., 120, 122, 124) of the electric vehicle 110, calculating a load weight on the electric vehicle 110, and adding the load weight to a curb weight of the electric vehicle 110 to determine the first gross weight of the electric vehicle 110. The systems of the electric vehicle 110 include the traction motor system 120, the suspension system 122 and the hitch system 124. The curb weight of the electric vehicle 110 may be stored (e.g., database 180, memory 212) and provided to the system for use in analysis.

In the first example method, receiving the second gross weight of the trailer 130 includes receiving a data from one or more sensors 134 related to a system (e.g., 140, 136) of the trailer 130, calculating a load weight on the trailer 130, and adding the load weight to a curb weight of the trailer 130 to determine the second gross weight of the trailer 130. The system of the trailer 130 includes at least one of the suspension system 140, the tongue system 136 and inertial system.

In a second example method, the vehicle computer 112 determines a range of the electric vehicle in accordance with the first gross weight of the electric vehicle 110 and the second gross weight of the trailer 130. In accordance with determining, the vehicle computer 112 selects the route in which a distance between the one or more charging stations (e.g., R420, R422, R424, R426, R428, R430, R460, R462) along the route are within the range of the electric vehicle 110. The second example method may include may include some or all of the steps of the first example method.

The second example method performed by the vehicle computer 112 may further include determining a range of the electric vehicle in further accordance with at least one of a grade of a road along the one or more routes and a length of the one or more routes, a change in elevation along each of the one or more routes, a driving characteristic of a driver of the electric vehicle 110, and/or an amount of precipitation falling along the route. Determining a range of the electric vehicle may further include determining an amount of energy remaining in a battery of the electric vehicle and a rate of use of energy from the battery along the one or more routes.

The second example method may further include prior to using a majority of an energy from the battery 116 of the electric vehicle 110 transferring an amount of energy to the battery 116 at a first charging station (e.g., R420, R422, R424, R426, R428, R430, R460, R462) to increase the range of the electric vehicle to travel to a next charging station along the route.

Some or all of the functions performed by the vehicle computer 112 in the above example methods may be performed by the server 170. Server 170 may receive data from sensors 114 of the electric vehicle 110 and sensors 134 of the trailer 130 via the wireless communication link 150 and the network 160 to perform the same or similar calculations as performed by the vehicle computer 112. The server 170 may calculate load weights, gross weights, identify potential routes, and use data to assess each potential route. The server 170 may select a route in accordance with assessing the potential routes.

The server 170 and/or the vehicle computer 112 may present potential routes with instructions and/or a result of assessment to allow a driver of the vehicle to select a route. The server 170 and/or the vehicle computer 112 may identify routes that are impractical or impossible to traverse and not select those routes or present those routes to driver for selection.

### AFTERWORD

The foregoing description discusses implementations (e.g., embodiments), which may be changed or modified without departing from the scope of the present disclosure as defined in the claims. Examples listed in parentheses may be used in the alternative or in any practical combination. As used in the specification and claims, the words ‘comprising’, ‘comprises’, ‘including’, ‘includes’, ‘having’, and ‘has’ introduce an open-ended statement of component structures and/or functions. In the specification and claims, the words ‘a’ and ‘an’ are used as indefinite articles meaning ‘one or more’. While for the sake of clarity of description, several specific embodiments have been described, the scope of the invention is intended to be measured by the claims as set forth below. In the claims, the term “provided” is used to definitively identify an object that is not a claimed element but an object that performs the function of a workpiece. For example, in the claim “an apparatus for aiming a provided barrel, the apparatus comprising: a housing, the barrel positioned in the housing”, the barrel is not a claimed element of the apparatus, but an object that cooperates with the “housing” of the “apparatus” by being positioned in the “housing”.

The location indicators “herein”, “hereunder”, “above”, “below”, or other word that refer to a location, whether specific or general, in the specification shall be construed to refer to any location in the specification whether the location is before or after the location indicator.

Methods described herein are illustrative examples, and as such are not intended to require or imply that any particular process of any embodiment be performed in the order presented. Words such as “thereafter,” “then,” “next,” etc. are not intended to limit the order of the processes, and these words are instead used to guide the reader through the description of the methods.

What is claimed is:

1. A method performed by a computer for selecting a route for travel by an electric vehicle, the method comprising:
identifying one or more routes between a starting location and a destination in accordance with a map data;
receiving a first gross weight of the electric vehicle;
receiving a second gross weight of a trailer attached to the electric vehicle;
in accordance with the first gross weight of the electric vehicle and the second gross weight of the trailer, determining at least one of an amount of energy and a duration of time to travel each of the one or more routes from the starting location to the destination; and
in accordance with determining, selecting the route in accordance with at least one of minimizing the amount of energy and the duration of time.

2. The method of claim 1 wherein determining comprises determining in further accordance with at least one of a grade of a road along the one or more routes and a length of the one or more routes.

3. The method of claim 1 wherein determining comprises determining in further accordance with a change in elevation along each of the one or more routes.

4. The method of claim 1 wherein determining comprises determining in further accordance with a range of electric vehicle for a remaining charge on a battery of the electric vehicle and a distance to a charging station.

5. The method of claim 1 wherein receiving the first gross weight of the electric vehicle comprises:
receiving a data from one or more sensors related to a system of the electric vehicle;
calculating a load weight on the electric vehicle; and
adding the load weight to a curb weight of the electric vehicle to determine the first gross weight of the electric vehicle.

6. The method of claim 5 wherein the system of the electric vehicle comprises at least one of a suspension system and a traction motor system.

7. The method of claim 1 wherein receiving the second gross weight of the trailer comprises:
receiving a data from one or more sensors related to a system of the trailer;
calculating a load weight on the trailer; and
adding the load weight to a curb weight of the trailer to determine the second gross weight of the trailer.

8. The method of claim 7 wherein the system of the trailer comprises at least one of a suspension system and inertial system.

9. A method performed by a computer for selecting a route for travel by an electric vehicle, the method comprising:
identifying one or more routes between a starting location and a destination in accordance with a map data;
identifying a respective location of one or more charging stations along the one or more routes;
receiving a first gross weight of the electric vehicle;
receiving a second gross weight of a trailer attached to the electric vehicle;
in accordance with the first gross weight of the electric vehicle and the second gross weight of the trailer, determining a range of the electric vehicle; and
in accordance with determining, selecting the route in which a distance between the one or more charging stations along the route are within the range of the electric vehicle.

10. The method of claim 9 wherein determining comprises determining the range in further accordance with at least one of a grade of a road along the one or more routes and a length of the one or more routes.

11. The method of claim 9 wherein determining comprises determining in further accordance with a change in elevation along each of the one or more routes.

12. The method of claim 9 wherein determining comprises determining in further accordance with a driving characteristic of a driver of the electric vehicle.

13. The method of claim 9 wherein determining comprises determining in further accordance with an amount of precipitation falling along the route.

14. The method of claim 9 wherein determining comprises determining an amount of energy remaining in a battery of the electric vehicle and a rate of use of energy from the battery along the one or more routes.

15. The method of claim 9 further comprising prior to using a majority of an energy from a battery of the electric vehicle transferring an amount of energy to the battery at a first charging station to increase the range of the electric vehicle to travel to a next charging station along the route.

16. An electric vehicle comprising:
a computer, the computer includes a communication circuit;
a first sensor coupled to the computer, the first sensor adapted to provide a first data regarding a physical characteristic of a system of the electric vehicle to the computer;
a battery for providing an energy to move the electric vehicle; wherein the computer:
determines a first gross weight of the electric vehicle in accordance with the first data from the first sensor;
identifies one or more routes between a starting location and a destination in accordance with a map data;
determines at least one of an amount of energy and a duration of time to travel each of the one or more routes from the starting location to the destination in accordance with the first gross weight of the electric vehicle; and
selects a route from the one or more routes in accordance with at least one of minimizing the amount of energy and the duration of time.

17. The electric vehicle of claim 16 wherein the computer determines the first gross weight of the electric vehicle by:
calculating a load weight on the electric vehicle in accordance with the first data from the first sensor; and
adding the load weight to a curb weight of the electric vehicle to determine the first gross weight of the electric vehicle.

18. The electric vehicle of claim 16 wherein:
the system of the electric vehicle comprises at least one of a suspension system and a traction motor system; and
the first data includes a least one of an amount of compression of the suspension system and an amount of force provided by the traction motor system to move the electric vehicle from a stop.

19. The electric vehicle of claim 16 further comprising a trailer, wherein:
the trailer is adapted to couple to and be pulled by the electric vehicle;
the trailer includes a second sensor, the second sensor is adapted to provide a second data to the computer;
the computer:
determines a second gross weight of the trailer in accordance with the second data from the second sensor; and
determines at least one of the amount of energy and the duration of time to travel each of the one or more routes from the starting location to the destination in accordance with the first gross weight of the electric vehicle and the second gross weight of the trailer.
